(19) United States
(12) Patent Application Publication
(10) Pub. No.: US 2008/0175983 A1
(43) Pub. Date: Jul. 24, 2008

(54) Water-resistant coating for computer digital data storage device

(76) Inventor: Robby Jay Moore, Auburn, CA (US)

Correspondence Address: Bruce H. Johnsonbaugh;Eckhoff & Hoppe, Suite 2800, 101 Montgomery Street, San Francisco, CA, 94104, US

(21) Appl. No.: 12/009,072

(22) Filed: Jan. 16, 2008

Related U.S. Application Data
(60) Provisional application No. 60/881,271, filed on Jan. 19, 2007.

(51) Int. Cl. C09D 163/00; C08G 65/00

(52) U.S. Cl. 427/96.6; 528/403

(57) ABSTRACT

A low cost method of applying a water-resistant coating to the exterior of a computer digital data storage device is provided. The storage device is compatible with industry standard 2.5 inch or 3.5 inch drive sizes and is either dipped into a reservoir of liquid elastomeric, rubberized epoxy compound or by applying a thermoset polyurethane polymer to the exterior surface of the storage device by reaction injection molding. Both methods produce a coating which has high thermal conductivity and high electrical resistance so that the storage device will operate properly. The resultant form of the water resistant coated digital data storage device is compatible with industry standard 2.5 inch and 3.5 inch computer hard drive bays. Both methods lend themselves to high speed automatic application, thereby greatly reducing the applied cost of the coating. The invention also pertains to the coatings, themselves, as applied to the exterior surfaces of a computer digital data storage device compatible with industry standard 2.5 inch and 3.5 inch computer hard drive bays.

### CROSS REFERENCE TO RELATED APPLICATION

This application is a continuation-in-part of U.S. patent application Ser. No. ______ filed on Oct. 30, 2007, which was a continuation-in-part of U.S. patent application Ser. No. 11/285,854 filed on Nov. 23, 2005, which was a continuation-in-part of U.S. patent application Ser. No. 11/112,552 filed on Apr. 22, 2005.

This application claims the benefit of and priority from U.S. provisional application Ser. No. 60/881,271 filed Jan. 19, 2007.

### BACKGROUND AND BRIEF SUMMARY OF INVENTION

The present invention is a significant improvement over the inventions of my U.S. Pat. Nos. 7,211,742 and 7,291,784, both of which are hereby incorporated by reference as though set forth in full. The present invention provides an improved water-resistant or waterproof coating for the operational computer digital data storage device as used in the environment of the above-identified patents and as may be used in other environments as well. The preferred digital storage device would be a device compatible with industry standard 2.5 inch and 3.5 inch hard disk drive bays. The coating of the present invention provides a cost effective water-resistant covering for the operating hard drive or digital memory device.

Protection of digital memory devices from loss of data caused by fire, water and various disasters has become critically important as storage devices increase in capacity of stored data. An important aspect of protecting data storage devices is the cost effectiveness of the coating. The coatings utilized in the present invention may be applied by high speed, automatic equipment, greatly reducing the applied cost of the coating.

The present invention provides an extremely low cost system for providing a water-resistant coating for digital data storage devices. An important aspect of the invention is to provide a coating having four required characteristics: First, the coating must be water-resistant or waterproof. Second, the coating must have high thermal conductivity. Third, the coating must have high electrical resistance. Fourth, the coating as applied must be inexpensive.

The present invention provides two specific embodiments that each satisfies the above four requirements.

A primary object of the invention is to provide a cost effective, water-resistant coating for digital data storage devices having high thermal conductivity and high electrical resistance.

### BRIEF DESCRIPTION OF THE DRAWINGS

FIG. 1 is a schematic illustration of a data storage device mounted in an enclosure, without a water-resistant coating applied; and

FIG. 2 is a schematic illustration of the data storage device of FIG. 1 after the water-resistant or waterproof coating of the invention has been applied.

### DETAILED DESCRIPTION OF THE DRAWINGS

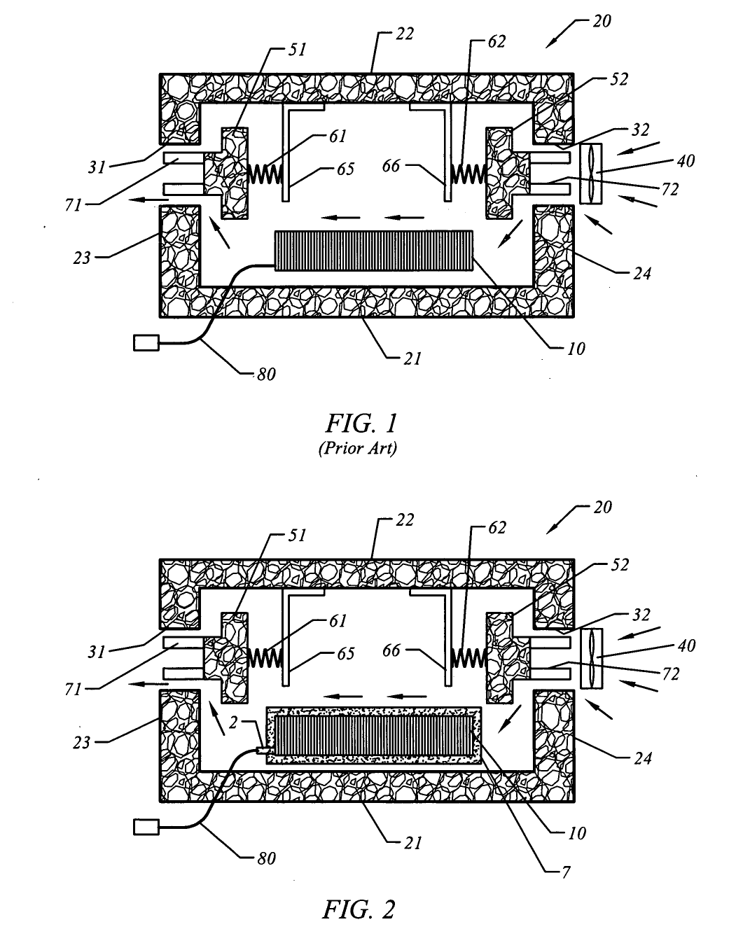

FIG. 1 is reproduced from the above-identified U.S. Pat. No. 7,211,742. FIG. 1 shows a data storage device 10 without a water-resistant coating. FIG. 1 is not described in detail here in the interest of brevity. The operation of the fire resistant enclosure is described fully in said '742 patent.

FIG. 2 is an illustration of the apparatus of FIG. 1 with the water-resistant coating 7 of the present invention after it has been applied to the digital data storage device 10. The water-resistant coating 7 is applied to the digital data storage device before the device is placed in the fire resistant enclosure 20. The coating is applied in one of two methods.

The first method is by dipping the digital data storage device 10 into a reservoir of liquid elastomeric, rubberized epoxy compound. The preferred compound is Cotronics “Duralco™ 4538,” available through Cotronics at www.cotronics.com. That coating is a thermally conductive coating to allow heat to escape from the operating digital data storage device. The coating 7 has high thermal conductivity and high electrical resistance. Before the coating is applied, a printed circuit board adapter 2 is connected to the data storage device 10 (and then covered during the dipping procedure) to allow electrical signals to pass through the coating 7. The application of the coating by dipping may be done automatically and at high speed to reduce the cost of the applied coating.

A second method of applying the water-resistant or waterproof coating 7 is by utilizing a reaction injection molding thermoset polyurethane polymer in the process known as reaction injection molding. This coating is applied by the technique utilized by Rimnetics and is available through the company and fully described at www.rimnetics.com, which description is incorporated herein by reference. The reaction injection molding technique produces a foam covering which surrounds the digital data storage device 7. The material has high thermal conductivity and high electrical resistance.

The coating material, itself, is “waterproof” in the sense it is impermeable to water. The phrase “water-resistant” is used herein and in the claims in the sense that the applied coating will have one or more holes in it to allow connection of the storage device to data and power lines; small amounts of water may leak through those holes.

Although the preferred use of the waterproof coating described herein is in conjunction with the fire resistant enclosure illustrated in FIGS. 1 and 2, the invention may also be utilized apart from a fire resistant enclosure. The waterproof coating will protect operating digital data storage devices in environments where water exposure and possible flooding is much more likely than exposure to fire. Such environments include shipboard data storage devices, data devices used in coastal environments and data storage devices utilized in other extremely wet environments.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. A low cost method of applying a water-resistant coating to the exterior of an operational computer digital data storage device comprising the steps:
connecting a printed circuit board adapter to said storage device, and
dipping said storage device into a reservoir of liquid elastomeric, rubberized epoxy compound, wherein said compound has high thermal conductivity and high electrical resistance.

2. A water-resistant coating for application to the exterior surfaces of an operational, computer digital data storage device wherein said coating comprises an elastomeric, rubberized epoxy having high thermal conductivity and high electrical resistance.

3. A low cost method of applying a water-resistant coating to the exterior of a computer digital data storage device comprising the steps:
connecting a printed circuit board adaptor to said storage device, and
applying a thermoset polyurethane polymer to said exterior surface by reaction injection molding to produce a foam covering having high thermal conductivity and high electrical resistance.

4. A water-resistant coating for application to the exterior surface of an operational, computer digital data storage device wherein said coating comprises a thermoset polyurethane polymer having high thermal conductivity and high electrical resistance.
